(19) United States
(12) Patent Application Publication
(10) Pub. No.: US 2007/0234579 A1
(43) Pub. Date: Oct. 11, 2007

(54) Implement holder

(76) Inventor: James F. Patrick, Muskogee, OK (US)

Correspondence Address: GABLE & GOTWALS, 100 WEST FIFTH STREET, 10TH FLOOR, TULSA, OK, 74103, US

(21) Appl. No.: 11/399,178

(22) Filed: Apr. 6, 2006

(51) Int. Cl. B23D 51/01; B27B 21/00

(52) U.S. Cl. 30/517

(57) ABSTRACT

An implement holder has an intermediate linear section pivotally attached to a proximate linear section and a distal linear section. An implement mounting bracket is pivotally attached to the distal linear section and a handle and controls are attached to the proximate linear section. One or more of the proximate, intermediate and distal linear sections may telescope. The proximate linear section may be pivotally attached to a vehicle.

### BACKGROUND OF THE INVENTION

This invention relates generally to an implement holder and more particularly concerns an implement holder which increases the range of access available to an operator in the use of the power tools.

The use of power tools in performing gardening and landscaping tasks can be a great timesaver. Gas or electric powered clippers are often used to trim hedges and shrubs and gas or electric powered chain saws can be used to trim branches. While these devices are generally handy, trimming or pruning of hedges and branches not readily accessible to an operator standing on the ground makes use of the tools more difficult.

One remedy for such situations is to stand on a ladder or step stool. This often provides the additional height necessary to reach the hedges, shrubs or branches needing to be trimmed. However, standing on these structures puts the operator in a precarious and unstable position, especially if it is necessary to reach away from the stepstool or ladder in order to reach the hedge, shrub or branch to be pruned or if the ground itself is not level.

Another solution to pruning or trimming hedges, shrubs and branches at higher levels is to use a power clipper or saw with an extended handle. Such devices typically have a unidirectional telescoping section and a single articulation at the end of the extension to allow for angled manipulation of the power tool. The drawback with such devices is that often the point at which the tool is to be applied is not on a unidirectionally accessible path from the operator. Such tasks ultimately require the operator to use an extremely tall ladder or other structure to stand at a level from which the tool can be unilaterally extended to the work point. Use of a tall ladder places the operator in an even more elevated and unstable position than the use of a footstool.

It is, therefore, an object of this invention to provide an implement holder capable of reaching high trimming or pruning jobs while the operator remains on the ground. Another object of this invention is to provide an implement holder which allows the operator to reach trimming and pruning tasks which are not accessible along a straight line of reach from the operator. A further object of this invention is to provide an implement holder which is extendable such that the length of the holder can be adjusted for the length necessary for the task at hand.

### SUMMARY OF THE INVENTION

In accordance with the invention, an implement holder is provided which has proximate, distal and intermediate linear sections. The intermediate linear section is pivotally attached to both the proximate and distal linear sections. The distal linear section has a mounting bracket for attaching an implement such as a hedge trimmer, chain saw or other power tool. Preferably, one or more of the proximate, intermediate or distal linear sections is capable of telescoping and the implement is pivotally mounted at the distal end of the distal linear section. A handle may be located on the aft end of the proximate linear section and may include controls allowing the operator to control the implement mounted on the distal linear section of the implement holder. The aft end of the proximate linear section may be attached to a vehicle and the controls for the implement as well as the controls for the implement holder hard-wired to the vehicle or operated by remote control.

### BRIEF DESCRIPTION OF THE DRAWINGS

Other objects and advantages of the invention will become apparent upon reading the following detailed description and upon reference to the drawings in which:

FIG. 1 is an elevation view illustrating the implement holder being used to trim the top of a tree or shrub;

FIG. 2 is a perspective assembly view of an articulating joint of the implement holder of FIG. 1; and

FIGS. 3 is a perspective view of the assembled articulating joint of FIG. 2.

While the invention will be described in connection with preferred embodiment thereof, it will be understood that it is not intended to limit the invention to that embodiment or to the details of the construction or arrangement of parts illustrated in the accompanying drawings.

### DETAILED DESCRIPTION

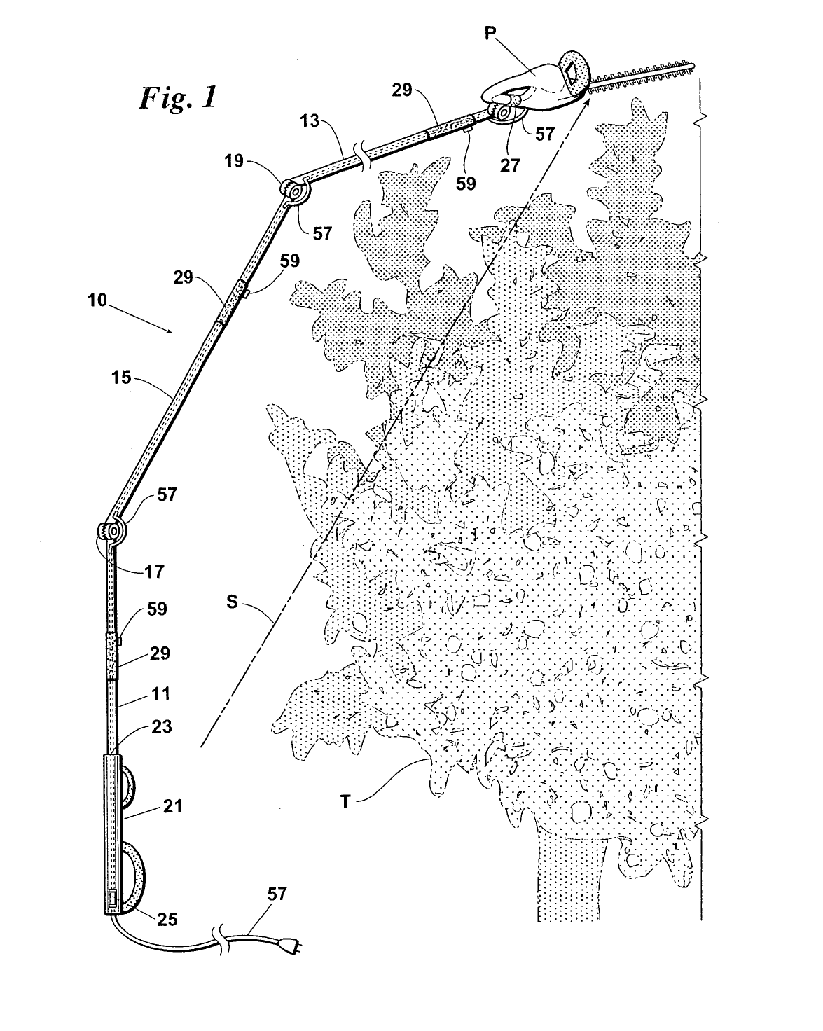

Looking now to FIG. 1, implement holder 10 of the present invention is used with an implement P to trim a tree T. As seen in FIG. 1, the tree T prevents the implement holder 10 from extending directly along the sight line S. Moreover, a single articulation joint would not resolve this problem.

In order to reach the trim point at the end of the sight line S, the implement holder 10 has a proximate linear section 11, a distal linear section 13 and one or more intermediate linear sections 15. The intermediate linear section 15 is attached to the proximate linear section 11 by a pivotal joint 17. The intermediate linear section 15 is also attached to the distal linear section 13 by a pivotal joint 19. A handle 21 is located on the proximal end 23 of the proximate linear section 11. The handle 21 is equipped with controls 25, such as an electric on-off switch wired to the implement P, to allow the operator to control the implement P. The implement P is secured to the distal linear section 13 by an implement mounting bracket 27. Any one or more of the proximate, distal and intermediate linear sections 11, 13 and 15 may be telescoping 29. The telescoped length may be fixed by use of set screws 59 or other means, manually or otherwise operated.

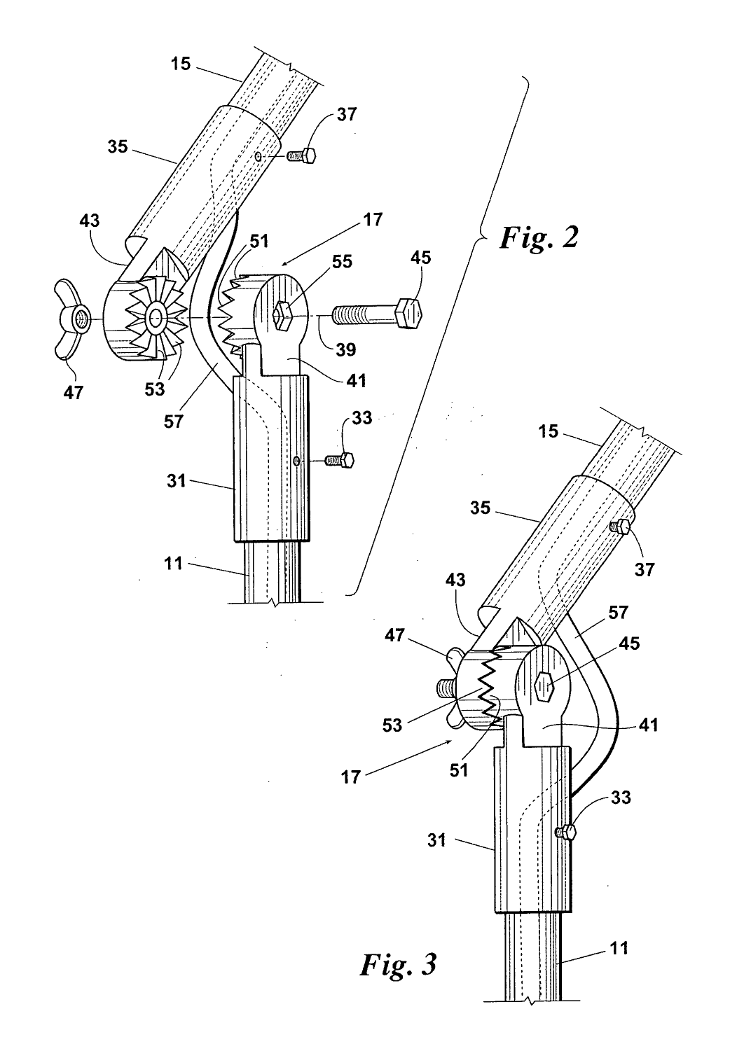

Turning to FIGS. 2 and 3, one embodiment of the proximal pivoted joint 17 is seen in greater detail. The distal end of the proximate linear section 11 is secured in a sleeve 31 by use of a set screw 33. The proximal end of the intermediate linear section 15 is also secured in a sleeve 35 by use of a set screw 37. The ends 41 and 43 of the sleeves 31 and 35 are rotationally engaged on an axis 39 perpendicular to the linear sections 11 and 15 and extending through a hex bolt 45 and wing nut 47. The ends 41 and 43, as shown, are cylindrical and extend longitudinally along the axis 39. Their engaging faces have radial teeth 51 and 53 to position the joint 17 in a selected angular orientation. Tightening the wing nut 47 on the bolt 45 with the head of the bolt 45 engaged in a seat 55 in the cylinder end 41 locks the joint 17 in this condition. The distal pivotal joint 19 may be similarly configured. The joint 17 shown is given as an example. Any known articulating joint capable of being locked, manually or otherwise, in a desired angular orientation can be used. The joints 17 and 19 may be universal and need not be aligned to articulate in the same plane. Apertures (not shown) may be provided through the linear sections 11, 13 and 15 for passage of the electrical wiring 57 through the linear sections 11, 13 and 15 and around the joints 17 and 19.

While FIG. 1 shows an implement holder 10 with a single intermediate linear section 15, multiple intermediate sections 15 could be used. If more than one intermediate linear section 15 is used, the sections would preferably be pivotally attached to one another.

The implements P that can be used with the implement holder 10 include, among others, tree trimmers, chain saws and claws for grasping larger branches. Articulation and telescoping of the sections 11, 13 and 15 and the mounting bracket 27 may be accomplished manually or electro-mechanically on smaller embodiments of the implement holder 10 or by hydraulic, pneumatic or electro-mechanical means for larger embodiments of the implement holder 10. The controls 25 may be hardwired to the implement holder 10 or to a vehicle supporting the implement holder or may be accomplished by radio remote control.

Thus, it is apparent that there has been provided, in accordance with the invention, an implement holder that fully satisfies the objects, aims and advantages set forth above. While the invention has been described in conjunction with a specific embodiment thereof, it is evident that many alternatives, modifications and variations will be apparent to those skilled in the art and in light of the foregoing description. Accordingly, it is intended to embrace all such alternatives, modifications and variations as fall within the spirit of the appended claims.

What is claimed is:

1. An implement holder comprising:
a proximate linear section;
a distal linear section with an implement mounting bracket; and
at least one intermediate linear section, said intermediate linear section being pivotally attached to said proximate linear section and pivotally attached to said distal linear section.

2. The holder of claim 1 further comprising an implement controller.

3. The holder of claim 1 further comprising a handle on said proximate section.

4. The holder of claim 3, said handle being on a proximal end of said proximate section.

5. The holder of claim 3, further comprising an implement controller located on said handle.

6. The holder of claim 1, said mounting bracket being pivotally mounted on said distal linear section.

7. The holder of claim 1, said proximate section telescoping.

8. The holder of claim 1, said distal section telescoping.

9. The holder of claim 1, said intermediate section telescoping.

10. The holder of claim 9, said proximate section telescoping.

11. The holder of claim 9, said distal section telescoping.

12. The holder of claim 11, said proximate section telescoping.
